(19) United States
(12) Patent Application Publication
(10) Pub. No.: US 2023/0049591 A1
(43) Pub. Date: Feb. 16, 2023

(54) POLYESTER-URETHANE COMPOSITIONS USEFUL FOR PRODUCING ULTRAVIOLET LIGHT RESISTANT COATINGS

(71) Applicant: Arkema Inc., King of Prussia, PA (US)

(72) Inventor: Kyu-Jun KIM, Cary, NC (US)

(21) Appl. No.: 17/788,324

(22) PCT Filed: Jan. 6, 2021
(86) PCT No.: PCT/US2021/012296

§ 371 Date: Jun. 23, 2022

Related U.S. Application Data
(60) Provisional application No. 62/960,738, filed on Jan. 14, 2020.

(51) Int. Cl. C08G 18/24; C08G 18/75; C08G 18/42; C09D 175/06

(52) U.S. Cl. CPC C08G 18/246; C08G 18/755; C08G 18/423; C09D 175/06

(57) ABSTRACT

The present invention relates to a polyester-urethane composition. In particular, the invention relates to aliphatic alkyl ring-containing compositions that are useful for producing ultraviolet light resistant coatings. The invention further relates to pigmented and clear coating compositions formulated with the polyester-urethane composition of the present invention. The polyester-urethane compositions may be crosslinked.

### FIELD OF THE INVENTION:

The invention relates to compositions resistant to UV light and water condensation.

### BACKGROUND OF THE INVENTION:

The coating industry needs a durable coating product for industrial and architectural applications where the required outdoor service time is as long as 10 years. Currently, polyvinylidene fluoride (PVDF) has been adopted in this market due to its excellent weatherability attributed to the high strength of C-F bonds, especially with regards to UV stability compared to typical C-C bonds. However, the process temperature during application of PVDF to a substrate should be higher than its melting temperature of 170° C. to achieve good coating properties due to the crystallinity of these polymers. As a result, about 30% acrylic polymer is typically blended with PVDF in order to decrease the crystallinity, improve the adhesion to substrates, and improve pigment wetting. Blending the acrylic resin into PVDF comes at the expense of undesirable decreased UV stability, increased stiffness and decreased impact strength. In addition, despite its excellent weatherability, the PVDF technology fails to provide high gloss coatings, which is desirable for many applications.

Silicone modified polyester (SMP) has been accepted in the coating industry as a “middle ground” resin in weatherability between PVDF and conventional polyester. The silicone modified polyester is produced by reacting a polymeric silicone with a typical molecular weight of 900 to 1,900 with a hydroxy functional polyester. However, outdoor weatherability of SMP is negatively affected by a distinctive phase separation of silicone and polyester phases.

Other efforts to produce weatherable compositions are illustrated below.

US 2010/0260954 describes a coating composition comprising a polymer having one or more polycyclic groups and a backbone that includes both ester and urethane linkages.

U.S. 2003/0104217 describes a polyurethane powder coating with high weather stability and flexibility comprising one (semi)crystalline polyester, one amorphous polyester and an isocyanate component.

Journal of Coatings Technology, p49-56, Vol. 74, No. 928, May 2002 describes the mechanical properties, tensile properties, fracture toughness, and viscoelastic properties of a polyurethane formed by reacting hexamethylene diisocyanate with high solids polyesters synthesized with 1,4-cyclohexanedicarboxylic acid, 1,3-cyclohexanedicarboxylic acid and with 1,4-cyclohexanedimethanol.

Progress in Organic Coatings, p49-58, Vol. 45 (2002) describes the mechanical, tensile and viscoelastic properties of a polyurethane formed by reacting hexamethylene diisocyanate isocyanurate with polyesters prepared using 1,4-cyclohexanedimethanol and cyclohexane diacids.

U.S. Pat. No. 3,962,522 describes a cured coating composition with the ability to withstand severe environmental conditions comprising the reaction product of an amine-aldehyde condensate and a hydroxyl-containing urethane which is formed from an organic polyisocyanate and a saturated polyester polyol and a lactone-based polyester formed by reacting lactones with a polyol or a hydroxy acid.

U.S. Pat. No. 4,410,667 describes a thermosetting, liquid, elastomeric, film-forming composition comprising a polyester polyol having at least 20 percent by weight cyclic moieties, a polyurethane polyol having a molecular weight of 8000 or less, a polyurethane polyol having a molecular weight of at least 12,000, and a curing agent consisting of aminoplast and polyisocyanates.

U.S. Pat. No. 4,419,407 describes a thermosetting, elastomeric coating composition comprising a hard polyester polyol having at least 20 percent by weight cyclic moieties and a polyurethane polyol having a molecular weight of 2,000, and a curing agent of aminoplast and polyisocyanates.

U.S. Pat. No. 4,530,977 describes a hydroxy-functional polyurethane formed by reacting organic diisocyanate with a stoichiometric excess of an essentially linear hydroxy-functional polyester, produced with C4-C10 aliphatic dicarboxylic acid or anhydride and a stoichiometric excess of C3- C8 aliphatic diol.

U.S. Pat. Nos. 4,540,766 and 4,548,998 describe a high solids, solvent-based, thermosetting, one component coating composition comprising a polyester-urethane polyol and a curing agent, wherein the polyester-urethane polyol comprises about 60 to 95 percent by weight acyclic moieties, and optionally up to about 30 percent by weight cyclic moieties and the organic polyisocyanate used to prepare the polyester-urethane polyol is aliphatic or aromatic.

U.S. Pat. No. 4,859,743 describes a high solids coating composition comprising a urethane polyol prepared from reactants comprising a hydroxyl functional polyether or polyester and at least 10 weight percent of an oligomeric polyisocyanate having isocyanate groups separated by at least 12 consecutive carbon atoms, and an aminoplast cross-linking agent.

U.S. Pat. No. 5,202,406 describes a high solids, polyurethane coating composition comprising the reaction mixture of a ketoxime-blocked polyisocyanate and a polyester polyol formed with 40 to 100 mole % of a dicarboxylic acid component being 1,4-cyclohexane dicarboxylic acid, wherein the most preferred diol is hexane 1,6-diol and the polyisocyanates are either aromatic or aliphatic.

U.S. Pat. No. 6,096,835 describes a film forming binder comprising 45 to 99% polyester polyol comprising cycloaliphatic moieties and 55 to 1% polyurethane polyol containing cyclic moieties, wherein the cyclic moieties are aromatic, cycloaliphatic, and/or heterocyclic.

None of these documents disclose a hydroxy functional polyester-urethane composition produced from reactants (monomers) comprising aliphatic alkyl ring containing polyisocyanate, aliphatic alkyl ring containing polycarboxylic acid, poly alkyl ester, and/or anhydride, and aliphatic alkyl ring containing polyol.

### SUMMARY OF THE INVENTION:

The present invention relates to a hydroxy functional polyester-urethane polymeric composition, and coating compositions formed from it that overcome the deficiencies of current coating materials. The inventive hydroxy functional polyester-urethane polymeric compositions have high gloss and excellent ultraviolet light and water resistance after being cured with a crosslinker. The crosslinker may be selected from, for example, melamine resin, blocked polyisocyanate, or polyisocyanates. Further, the present invention discloses a hydroxy functional polyester-urethane polymeric composition produced from reactants (also referred to herein as monomers) each of which comprise at least one aliphatic alkyl ring. The reactants (monomers) are: polyisocyanate bearing at least one aliphatic alkyl ring; polycarboxyl compound bearing at least one aliphatic alkyl ring; and polyol bearing at least one aliphatic alkyl ring. Namely, all three of the reactants (monomers) used to prepare the polyester-urethane polymeric composition as disclosed herein comprise at least one component having at least one aliphatic alkyl ring structure. The aliphatic alkyl ring structure may be monocyclic or polycyclic. Examples of suitable polycyclic groups include bicyclic groups, tricyclic groups, and polycyclic groups including four or more ring groups.

According to an aspect of the invention, a hydroxy functional polyester-urethane composition is disclosed. The composition comprises, consists essentially of, or consists of, as polymerized monomers, a), b) and c):

a) A polyol comprising at least one aliphatic alkyl ring, wherein the at least one aliphatic alkyl ring bears at least two substituents that each comprise at least one hydroxyl group and wherein the remaining substituents on the polyol are selected from the group consisting of hydrogen, C1-C10 alkyl groups, and combinations thereof.

b) A polycarboxyl compound comprising at least one aliphatic alkyl ring, wherein the at least one aliphatic alkyl ring bears at least two substituents that each comprise at least one carboxyl group; wherein the at least one carboxyl group comprises a functional group selected from the group consisting of a carboxylic acid, an alkyl ester, an acyl halide, an anhydride and combinations thereof; and wherein the remaining constituents on the aliphatic alkyl ring are selected from the group consisting of hydrogen, C1-C10 alkyl groups, and combinations thereof. The polycarboxyl compound may comprise at least one aliphatic alkyl ring wherein the at least one aliphatic alkyl ring bears two substituents that together form an anhydride group. These two substituents may be neighboring substituents on the aliphatic alkyl ring.

c) A polyisocyanate comprising at least one aliphatic alkyl ring, wherein the at least one aliphatic alkyl ring bears at least two substituents that each comprise at least one isocyanate group, wherein the remaining substituents on the at least one aliphatic alkyl ring are selected from the group consisting of hydrogen, C1-C10 alkyl groups, and combinations thereof.

According to another aspect of the invention, crosslinked compositions comprising the hydroxy functional polyester-urethane compositions of the invention which have been reacted with a crosslinking agent are disclosed.

According to yet another aspect of the invention, a coating composition comprising the hydroxy functional polyester-urethane compositions of the invention and at least one additional component are disclosed.

The novel polyester-urethane compositions of the invention produce long lasting outdoor coatings overcoming continuous sun light exposure and moisture attack. Therefore, the compositions of the invention can be used a replacement for PVDF and silicone modified polyesters based coatings.

Further areas of applicability will become apparent from the description provided herein. It should be understood that the description and specific examples are intended for purposes of illustration only and are not intended to limit the scope of the present disclosure.

### DETAILED DESCRIPTION

The invention generally provides for a hydroxy functional polyester urethane composition that is formed from at least three types of monomers: a polyol comprising at least one aliphatic alkyl ring; a polycarboxyl compound comprising at least one aliphatic alkyl ring; and a polyisocyanate comprising at least one aliphatic alkyl ring. These mutually reactive functional groups (hydroxy, carboxyl and isocyanate) are bonded to their respective aliphatic alkyl rings such that the backbone of the resulting hydroxy functional polyester urethane comprises the aliphatic rings from each of the polyol, the polycarboxyl compound and the polyisocyanate. The hydroxy functional polyester urethane composition is made by first reacting a molar excess of the polyol with the polycarboxyl compound to produce a hydroxy functional polyester. A molar excess of hydroxy functional group of this hydroxy functional polyester is reacted with the polyisocyanate to produce the hydroxy functional polyester urethane.

Unless otherwise indicated, all percentages herein are weight percentages.

“Polymer” as used herein, is meant to include organic molecules formed from at least three monomers and that at least one of each monomer is selected from polyol, polycarboxyl compound and polyisocyanate. The polymers disclosed herein may have a weight average molecular weight of 500 g/mol or higher as measured by gel permeation chromatography.

Molecular weight is recited in g/mol or Dalton unless stated otherwise. For polymeric compositions, the molecular weight is understood to refer to weight average molecular weight (MW), unless stated otherwise. Weight average molecular weight is measured using gel permeation chromatography calibrated by polystyrene standards.

“Aliphatic alkyl ring” as used herein means a non-aromatic, non-functional group containing carbon-hydrogen cyclic structure. The cyclic structure may have non-aromatic double bonds.

“Polycarboxyl compound” as used herein means a compound having at least one functional group capable of reacting with two moles of alcohol or at least two functional groups each capable of reacting with one mole of alcohol to form an ester and another small molecule, such as water, an alcohol or a halogen acid. Accordingly, carboxylic acids, anhydrides, alkyl esters, and acyl halides are all considered to be carboxyl compounds. According to this meaning, a polycarboxyl compound may for example comprise two carboxylic acid groups, one anhydride group, or may comprise one carboxylic acid functional group and one alkyl ester group. Regarding the special case of anhydride compounds: although one substituent on the aliphatic alkyl ring may have one anhydride group in rare cases, most commercially available materials have one anhydride group formed by two neighboring substituents on the aliphatic alkyl ring. This is the preferred structure for such polycarboxyl compounds comprising an anhydride functional group.

“Alkyl ester” as used herein means an ester group in which the non-carbonyl oxygen is bonded to an alkyl group, such as a methyl group, or an ethyl group. Therefore, when the term “alkyl ester” is used herein in relation to an aliphatic alkyl ring bearing a substituent comprising an alkyl ester group, this should be understood to mean that the carbonyl carbon of the ester group is bonded closest to the aliphatic alkyl ring.

“Neighboring substituents” means at least two substituents which are directly adjacent to one another.

A hydroxy functional polyester-urethane composition is provided. The hydroxy functional polyester-urethane composition comprises, as polymerized monomers:

a) A polyol comprising at least one aliphatic alkyl ring. The polyol comprising at least one aliphatic alkyl ring comprises at least two sub stituents on the at least one aliphatic alkyl ring that each comprise at least one hydroxyl group. That is, the polyol contains at least one aliphatic alkyl ring which bears at least two substituents that are comprised of one or more hydroxyl groups. For example, such a substituent may be a hydroxyl substituent itself (i.e., an —OH group directly bonded to a carbon atom which is part of the aliphatic alkyl ring) or a substituent in which an —OH group is not directly bonded to a carbon atom which is part of the aliphatic alkyl ring. Examples of the latter type of substituent include —CH₂OH (as in the case of cyclohexane dimethanol) and —C(CH₃)₂-cyclohexyl-OH, wherein cyclohexyl is a cyclohexane ring (as in the case of 4,4′-isopropylidenedicyclohexanol). The remaining substituents on the polyol may be selected from the group consisting of hydrogen, C1-C10 alkyl groups, and combinations thereof. The aliphatic alkyl ring may comprise six carbons. The aliphatic alkyl ring may comprise five, seven or eight carbons. Polyols comprising at least one six carbon aliphatic alkyl ring are preferred. The aliphatic alkyl ring or rings may have at least one double bond, but is (are) not aromatic. According to certain embodiments, the polyol contains at least two hydroxyl groups (i.e., the polyol is a diol). The polyol may comprise more than two hydroxyl groups. Preferably, the hydroxyl groups are primary and/or secondary hydroxyl groups.

b) A polycarboxyl compound comprising at least one aliphatic alkyl ring bearing at least two substituents that each comprise at least one carboxyl group or two neighboring substituents that form an anhydride group. The at least one carboxyl group comprises a functional group selected from the group consisting of a carboxylic acid, an alkyl ester, an acyl halide, and combinations thereof. The remaining constituents on the aliphatic alkyl ring are selected from the group consisting of hydrogen, C1-C10 alkyl groups, and combinations thereof. That is, the polycarboxyl compound contains at least one aliphatic alkyl ring which bears at least two substituents each comprising a carboxyl group to react with one mole of alcohol or the polycarboxyl compound contains at least one aliphatic alkyl ring which bears two neighboring substituents that together form an anhydride to react with two moles of alcohol. For example, such a substituent may be a carboxylic acid substituent itself (i.e., a —CO₂H group directly bonded to a carbon atom which is part of the aliphatic alkyl ring, or a carboxylic acid group bonded to a carbon atom which is part of the aliphatic alkyl ring through an alkyl group. For example, such a substituent may be an alkyl ester substituent itself (i.e., the CO₂-alkyl is directly bonded to a carbon atom which is part of the aliphatic alkyl ring through carbonyl carbon), or an alkyl ester group bonded to a carbon atom which is part of the aliphatic alkyl ring through an alkyl group (i.e., aliphatic alkyl ring -alkyl group-CO₂-alkyl group). The at least one aliphatic alkyl ring of the polycarboxyl compound may bear at least two substituents that together form an anhydride group. The anhydride group may be directly bonded to the aliphatic alkyl ring through the carbonyl carbon or bonded via an alkyl group. Similarly, the acyl halide may be may be directly bonded to the aliphatic alkyl ring through the carbonyl carbon or bonded via an alkyl group. The at least two substituents on the at least one aliphatic alkyl ring of the polycarboxyl compound may comprise two different types of the functional groups, for instance one of the at least two substituent may be a carboxylic acid group and the other may be an alkyl ester. The aliphatic alkyl ring of the polycarboxyl compound may comprise six carbons. The aliphatic alkyl ring may comprise five, seven or eight carbons. Polycarboxyl compounds comprising at least one six carbon aliphatic alkyl ring are preferred. The aliphatic alkyl ring or rings may have at least one double bond, but is (are) not aromatic. According to certain embodiments, the polycarboxyl compound contains two carboxylic acid groups (i.e., the polycarboxyl compound is a dicarboxylic acid). According to other embodiments, the polycarboxyl compound contains one or two anhydride groups. According to some embodiments, the polycarboxyl compound contains two alkyl ester groups. According to some embodiments the polycarboxyl compound contains two acyl halide groups.

c) A polyisocyanate comprising at least one aliphatic alkyl ring. The at least one aliphatic alkyl ring of the polyisocyanate bears at least two substituents that each comprise at least one isocyanate group. That is, the polyisocyanate contains at least one aliphatic alkyl ring which bears at least two substituents that are comprised of one or more isocyanate groups. For example, such a substituent may be an isocyanate substituent itself (i.e., an —NCO group directly bonded to a carbon atom which is part of the aliphatic alkyl ring through nitrogen atom) or a substituent in which an alkyl-NCO group is bonded to a carbon atom which is part of the aliphatic alkyl ring through alkyl group. Examples of the latter type of substituent include —CH₂NCO (as in the case of isophorone diisocyanate) and —CH₂-cyclohexyl-NCO, wherein cyclohexyl is a cyclohexane ring (as in the case of 4,4′-diisocyanatodicyclohexylmethane). The remaining substituents on the aliphatic alkyl ring of the polyisocyanate may be selected from the group consisting of hydrogen, C1-C10 alkyl groups, and combinations thereof. The aliphatic alkyl ring may comprise six carbons. The aliphatic alkyl ring may comprise five, seven or eight carbons. Polyisocyanates comprising at least one six carbon aliphatic alkyl ring are preferred. The aliphatic alkyl ring or rings may have at least one double bond, but is not aromatic.

### Exemplary Structures of Aliphatic Alkyl Ring Monomers (Reactants) Comprising the Polyester-Urethane

As a non-limiting example, aliphatic alkyl ring structures in the monomers that may comprise the inventive polyester urethane may have the following exemplary six carbon aliphatic alkyl ring structures:

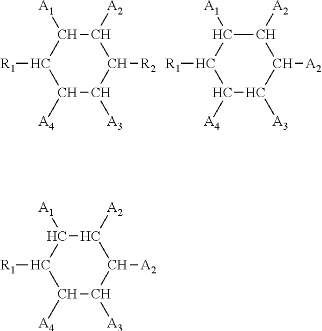

In the above structures, A₁, A₂, A₃, A₄ may be hydrogen, or alkyl groups with one to 10 carbons. R₁, R₂ may be chemical moieties that comprise the functional groups of the monomers that form the polyester-urethane:

Polyol containing at least one aliphatic alkyl ring: R₁, R₂ may comprise hydroxyl groups and/or alkyl hydroxyl groups.

Polycarboxyl compound containing at least one aliphatic alkyl ring: R₁, R₂ may comprise carboxylic acid groups, acyl halide groups, and/or alkyl ester groups; or R₁ and R₂ together may comprise an anhydride.

Polyisocyanate containing at least one aliphatic alkyl ring: R₁, R₂ may comprise isocyanate groups and/or alkyl isocyanate groups.

Any or all of the aliphatic alkyl rings may comprise one or more double bonds, but are not aromatic. As noted above, any or all of the polyol, polycarboxyl compound, and the polyisocyanate may comprise more than one aliphatic alkyl ring. If more than one aliphatic alkyl ring is present, then the at least two functional groups may be on one of the rings, or the at least two functional groups may each be on a different aliphatic alkyl ring.

The hydroxy functional polyester-urethane composition may comprise at least 0.0045, or at least 0.005 or more, or at least 0.01 or at least 0.1 or more moles of aliphatic alkyl rings per gram of the composition. The moles of aliphatic alkyl ring per gram of the composition is calculated as follows.

Moles of aliphatic alkyl ring per gram of the polyester-urethane composition=

$$\frac{\sum ( Mr ) ( \frac{Wr}{MWr} )}{Tw}$$

Where: Mr is moles of aliphatic alkyl ring per mole of reactant r; Wr is weight of reactant r; MWr is the molecular weight of reactant r; and Tw is the weight of the polyester-urethane composition calculated from the total weight of all the reactants by deducting the total weight of the volatiles generated from the condensation reaction during the process as follows (* meaning “X” or “multiplication”).

Tw=Total weight of all the reactants−18.015*moles of carboxylic acid−1*18.015*moles of monoanhydride−2*18.015*moles of dianhydride−(alkyl molecular weight+17.0)*moles of alkylester−(halide molecular weight+1.015)*moles of acyl halid

The hydroxy functional polyester-urethane composition may comprise at least 5 weight percent of the polyol comprising at least one aliphatic alkyl ring. The hydroxy functional polyester-urethane composition may comprise at least 6, 7, 8, 9, 10, 12, 14, 16, 18, 20, 23, 25, 30, 35, 40, 45, 50, 55, 60, 65, or 70 weight percent of the polyol comprising at least one aliphatic alkyl ring. The hydroxy functional polyester-urethane composition may comprise from 5-70, 10-70, 20-60, or from 30-50 weight percent of the polyol comprising at least one aliphatic alkyl ring.

The hydroxy functional polyester-urethane composition may comprise at least 5 weight percent of the polycarboxyl compound comprising at least one aliphatic alkyl ring. The hydroxy functional polyester-urethane composition may comprise at least 6, 7, 8, 9, 10, 12, 14, 16, 18, 20, 23, 25, 30, 35, 40, 45, 50, 55, 60, 65, or 70 weight percent of the polycarboxyl composition comprising at least one aliphatic alkyl ring. The hydroxy functional polyester-urethane composition may comprise from 5-70, 10-70, 20-60, 15-40, or from 30-50 weight percent of the polycarboxyl composition comprising at least one aliphatic alkyl ring.

The hydroxy functional polyester-urethane may comprise at least 5 weight percent of the polyisocyanate comprising at least one aliphatic alkyl ring. The hydroxy functional polyester-urethane composition may comprise at least 6, 7, 8, 9, 10, 12, 14, 16, 18, 20, 23, 25, 30, 35, 40, 45, 50, 55, 60, 65, or 70 weight percent of the polyisocyanate comprising at least one aliphatic alkyl ring. The hydroxy functional polyester-urethane composition may comprise from 5-70, 10-70, 20-60, 15-40, or from 30-50 weight percent of the polyisocyanate comprising at least one aliphatic alkyl ring.

### Polyols Comprising an Aliphatic Alkyl Ring

Useful aliphatic alkyl ring-containing polyols may contain one or more aliphatic alkyl rings and two or more hydroxyl groups. Examples of suitable aliphatic alkyl ring containing polyols may include, but are not limited to, cyclohexane dimethanol, cyclohexane diol, cyclohexane triol, cyclohexane tetraol, 4,4′-isopropylidenedicyclohexanol, and mixtures thereof.

### Polycarboxyl Compounds Comprising an Aliphatic Alkyl Ring

Useful aliphatic alkyl ring-containing carboxylic acid, alkyl ester, acyl halide, and/or anhydride may comprise one or more aliphatic alkyl rings, two or more carboxylic groups, two or more alkyl esters, and one or more anhydride groups. Examples of aliphatic alkyl rings containing functional groups comprising carboxylic acid, alkyl ester, acyl halide, and/or anhydride may include, but are not limited to, tetrahydrophthalic anhydride, hexahydrophthalic anhydride, dimethyl cyclohexyl dicarboxylate, diethyl cyclohexyl dicarboxylate, hexahydro methyl phthalic anhydride, 1,3-cyclohexane dicarboxylic acid, 1,4-cyclohexane dicarboxylic acid, 1,3-cyclohexanedicarbonyl dichloride, 1,4-cyclohexanedicarbonyl dichloride, and mixtures thereof.

### Polyisocyanates Comprising an Aliphatic Alkyl Ring

Useful aliphatic alkyl ring-containing polyisocyanates may comprise one or more aliphatic alkyl rings and two or more isocyanate groups. Examples of suitable aliphatic alkyl ring-containing polyisocyanates include, but are not limited to, isophorone diisocyanate, 4,4′diisocyanatodicyclohexylmethane, and mixtures thereof.

In one embodiment of the hydroxy functional polyester-urethane composition of the invention, the polyol may be at least one polyol selected from the group consisting of cyclohexane dimethanol, 4,4′-isopropylidenedicyclohexanol, and mixtures thereof; the polycarboxyl compound may be at least one selected from the group consisting of hexahydrophthalic anhydride, 1,3-cyclohexane dicarboxylic acid, 1,4-cyclohexane dicarboxylic acid, and mixtures thereof; and the polyisocyanate may be at least one selected from the group consisting of isophorone diisocyanate, 4,4′-diisocyanatodicyclohexylmethane, and mixtures thereof.

### Other Polyols

In addition to the polyol comprising at least one aliphatic alkyl ring, the hydroxy functional polyester-urethane composition may further comprise, as polymerized monomers, acyclic aliphatic polyols as well. Non-limiting examples include acyclic aliphatic polyols containing from 2 to 12 carbons can be used. Non-limiting examples include 1,10-decanediol; 1,12-dodecanediol, 1,2-butanediol; 1,4-butanediol; ethylene glycol, propylene glycol, trimethylol propane, trimethylol ethane, trimethyl pentanediol, neopentylglycol, pentaerythritol, 2-methyl 1,3-propane diol, methyl pentanediol, and 1,6-hexanediol. If present, the polyester-urethane composition may comprise up to 15, 20, 25, 30, 35, 40, 45, or 50 weight percent of these acyclic aliphatic polyols.

### Other Polycarboxyl Compounds

In addition to the polycarboxyl compound comprising at least one aliphatic alkyl ring, the hydroxy functional polyester-urethane composition may further comprise, as polymerized monomers, acyclic aliphatic polycarboxyl compounds. Examples of such acyclic aliphatic polycarboxyl compounds are: acyclic aliphatic polycarboxylic acid, acyclic aliphatic polyalkyl ester, acyclic aliphatic polyacyl halide, or acyclic aliphatic anhydride that do not comprise an aliphatic alkyl ring. Non-limiting examples of acyclic aliphatic polycarboxylic acids are those containing from 4 to 18 carbons, such as succinic acid, glutaric acid, adipic acid, suberic acid, and sebacic acid. Non-limiting examples of acyclic aliphatic polyalkyl esters that do not comprise an aliphatic alkyl ring are from 4 to 22 carbons, such as succinic acid dimethyl ester, succinic acid diethyl ester, glutaric acid dimethyl ester, glutaric acid diethyl ester, adipic acid dimethyl ester, adipic acid diethyl ester, suberic acid dimethyl ester, suberic acid diethyl ester, sebacic acid dimethyl ester, and sebacic acid diethyl ester. Non-limiting examples of acyclic aliphatic anhydrides that do not comprise an aliphatic alkyl ring are those containing from 4 to18 carbons, such as succinic anhydride, glutaric anhydride, maleic anhydride, adipic anhydride, and suberic anhydride. Non-limiting examples of acyclic aliphatic polyacyl halides that do not comprise an aliphatic alkyl ring are from 4 to 22 carbons, such as succinyl chloride, glutaryl chloride, adipyl chloride, suberoyl dichloride, and sebacoyl chloride. If present, the polyester-urethane urethane composition may comprise up to 45 weight percent of acyclic aliphatic polycarboxylic acids, acyclic aliphatic polyalkyl ester, acyclic aliphatic acyl halide, and/or acyclic aliphatic anhydride that do not comprise an aliphatic alkyl ring or up to 15, 20, 25, 30, 35, 40, 45 or 50 weight percent of acyclic aliphatic polycarboxylic acids, acyclic aliphatic polyalkyl ester, and/or acyclic aliphatic anhydride that do not comprise an aliphatic alkyl ring.

### Other Polyisocyanates

In addition to the polyisocyanate comprising at least one aliphatic alkyl ring, the hydroxy functional polyester-urethane composition may further comprise, as polymerized monomers, acyclic aliphatic polyisocyanate, biuret polyisocyanate, or isocyanurate polyisocyanate as well. Non-limiting examples of such acyclic aliphatic polyisocyanates comprising from 4 to 14 carbons are hexamethylene diisocyanate, and decamethylene diisocyanate. If present, the polyester-urethane composition may comprise up to 15, 20, 25, 30, 35, 40, 45 or 50 weight percent of acyclic aliphatic polyisocyanates comprising from 4 to 14 carbons.

### Other Reactants

In addition to polyols, polycarboxyl compound, and polyisocyanate, monomeric alkoxy silane may be used as reactant. Monomeric silane means the compound with alkoxy functional group(s) where only one silicone atom is present. Non-limiting examples of alkoxy silane are trimethoxy silane, triethoxy silane, methyl dimethoxy silane, methyl diethoxy silane, methyl trimethoxy silane, methyl triethoxy silane, propyl trimethoxy silane, propyl triethoxy silane, propyl trimethoxy silane, and dimethoxy dimethyl silane, preferably, methyl dimethoxy silane, methyl diethoxy silane, methyl trimethoxy silane, methyl triethoxy silane, propyl trimethoxy silane, propyl triethoxy silane, propyl trimethoxy silane, and dimethoxy dimethyl silane, most preferably, propyl trimethoxy silane and dimethoxy dimethyl silane.

### Preparation of the Hydroxy Functional Polyester-Urethane

The hydroxy-containing polyester-urethane composition of the present invention may be prepared in two steps. In the first step, a hydroxy terminated polyester may be produced by reacting the polyol compound(s) and the polycarboxyl compound(s) at temperatures of higher than 20, 150, or 200° C. while removing the water, halide acid or alcohol formed. The molar ratio of the hydroxyl groups to the carboxylic, anhydride, acyl halide and alkyl ester groups may be higher than 1, such that the resultant polyester is OH terminated. One mole of anhydride group is considered two moles of carboxylic groups. A suitable range of molar ratio of hydroxyl to carboxylic, acyl halide and alkyl ester groups may be 1.2 to 5.0, preferably, 1.3 to 4.0, or more preferably, 1.4 to 3.0. An organic solvent without a functional group, for example, xylene, toluene, methyl amyl ketone, or naphtha, in the range of 0.5 to 3.0 weight percent based on the total reactants (monomers) may be included as a processing aid to facilitate the condensation reaction and clean the sublimed solids inside the reaction vessel.

In the second step, an organic solvent and a catalyst may be mixed with the aliphatic alkyl ring containing-polyester produced in the first step and the aliphatic alkyl ring containing-polyisocyanate(s) may be gradually charged into a reactor over a period of 20 minutes to 3 hours at temperatures from 60 to 150° C. The amount of polyisocyanate is adjusted to achieve a hydroxyl value of the polyester-urethane based on the polyester urethane composition of 10 to 250, preferably 20 to 200, or more preferably 25 to 150. Hydroxyl value is defined as the number of milligrams of potassium hydroxide required to neutralize the acetic acid produced on acetylation of one gram of a chemical substance that contains free hydroxyl groups.

### Catalysts for Polyester-Urethane Preparation

As mentioned above, the formation of the polyester-urethane disclosed herein may be carried out in the presence of 0.01% to 2% by weight of catalyst based on the total charge of the reactants (monomers). Examples of suitable catalysts include, but are not limited to, dibutyltin oxide, dibutyltin dilaurate, triethylamine, tin(II) octoate, 1,4-diazabicyclo [2.2.2]octane, 1,4-diazabicyclo [3.2.0]-5-nonene, penta-dimethyl diethylene triamine, dimethylaminopropyl amine, 2,2-N,N benzyldimethylamine, dimethylcyclohexylamine, 2,2-dimorphoinodiethyl ether, tetramethylethylenediamine, dimethyltetrahydropyrimidine, bis-(2-dimethylaminoethyl)-ether, triethylenediamine and 1,5-diazobicyclo [5.4.0]-7-undecene.

### Organic Solvent for Polyester-Urethane Preparation

The formation of the polyester-urethane disclosed herein may be carried out in the presence of 10% to 200% by weight of an organic solvent based on the total charge of the monomers (reactants). The organic solvent should not contain groups reactive to isocyanate such as hydroxyl, aceto and amine groups. Example of suitable solvent include, but are not limited to, N-methylpyrrolidone, mineral spirits, naphtha, methyl amyl ketone, xylene, toluene methyl isobutyl ketone, ethyl acetate, diethylene glycol monobutyl ether acetate, ethylene glycol monobutyl ether acetate, dipropylene glycol monobutyl ether acetate, propylene glycol monobutyl ether acetate, propylene glycol mono methyl ether acetate, isobutyl acetate, n-propyl acetate, ethyl 3-ethoxypropionate, n-butyl propionate, triethylene glycol monobutyl ether, methyl isoamyl ketone, oxohexyl acetate, aromatic hydrocarbons, diethylene glycol monoethyl ether acetate, isophorone, methyl propyl ketone, n-butyl acetate, para-chlorobenzotrifluoride, acetone, dimethyl carbonate, t-butylacetate and mixture thereof.

Also provided is a coating composition comprising the hydroxy functional polyester-urethane composition and at least one additional component. The at least one additional component is selected from the group consisting of a crosslinking agent, an organic solvent, and a pigment.

### Organic Solvents for Coating Composition

An organic solvent may be useful for the production of a coating composition to achieve the desired viscosity for application of the coating composition. The organic solvent may be selected from, but is not limited to, aliphatic solvents, aromatic solvents, ketone solvents, glycol ether solvents, ester solvents, alcoholic solvents and carbonate solvents such as mineral spirits, naphtha, methyl amyl ketone, xylene, toluene, methyl isobutyl ketone, ethyl acetate, diethylene glycol mono butyl ether acetate, ethylene glycol monobutyl ether acetate, dipropylene glycol mono butyl ether acetate, propylene glycol monobutyl ether acetate, ethylene glycol monobutyl ether, isobutyl acetate, n-propyl acetate, ethylene glycol monopropyl ether, ethyl 3-ethoxypropionate, n-butyl propionate, dipropylene glycol monobutyl ether, triethylene glycol monobutyl ether, methyl isoamyl ketone, oxo-hexyl acetate, tripropylene glycol monomethyl ether, aromatic hydrocarbon, propylene glycol phenyl ether, diethylene glycol monomethyl ether, diethylene glycol monoethyl ether acetate, isophorone, methyl propyl ketone, n-butyl acetate, propylene glycol monomethyl ether, para-chlorobenzotrifluoride, acetone, dimethyl carbonate, acetone, t-butylacetate, N-methylpyrrolidone, mineral spirits, naphtha, methyl amyl ketone, xylene, toluene, methyl isobutyl ketone, ethyl acetate, diethylene glycol mono butyl ether acetate, ethylene glycol mono butyl ether acetate, di propylene glycol monobutyl ether acetate, propylene glycol monobutyl ether acetate, propylene glycol mono methyl ether acetate, ethylene glycol monobutyl ether, isobutyl acetate, n-propyl acetate, ethylene glycol monopropyl ether, ethyl 3-ethoxypropionate, n-butyl propionate, dipropylene glycol monobutyl ether, triethylene glycol monobutyl ether, methyl isoamyl ketone, oxo-hexyl acetate, tripropylene glycol monomethyl ether, aromatic hydrocarbon, propylene glycol phenyl ether, diethylene glycol monomethyl ether, diethylene glycol monoethyl ether acetate, isophorone, methyl propyl ketone, n-butyl acetate, propylene glycol monomethyl ether, para-chlorobenzotrifluoride, acetone, dimethyl carbonate, t-butylacetate, and mixtures thereof.

### Pigments

Suitable pigments include, but are not limited to, titanium dioxide, zinc oxide, iron oxide, organic dyes, calcium carbonate, nepheline syenite, feldspar, diatomaceous earth, talc, aluminosilicates, silica, alumina, clay, kaolin, mica, pyrophyllite, perlite, baryte, or wollastonite, and the mixture thereof.

### Coating Composition

Also provided is a coating composition comprising the hydroxy functional polyester-urethane composition as disclosed herein and a crosslinking agent. As is known in the art, a “one-component” crosslinkable coating composition may be provided that comprises the hydroxy functional polyester-urethane composition and a crosslinking agent. The crosslinking agent in such a “one-component” crosslinkable composition is capable of reacting with the hydroxy functional polyester-urethane composition under suitable conditions after being applied on the substrate while remaining mostly chemically unreacted during the storage. In other embodiments, the crosslinking agent may be combined with the hydroxy functional polyester-urethane composition disclosed herein, just prior to use of the composition for “two component” crosslinkable coating composition where the crosslinking agent reacts immediately with the hydroxy functional polyester-urethane when blended. The crosslinking agent may be selected from the group consisting of a melamine resin, a polyisocyanate, a blocked polyisocyanate, and mixtures thereof.

### Melamine Resin Crosslinker

A hydroxy functional polyester-urethane composition of the present invention may be crosslinked or be capable of crosslinking by combining it with 5 to 50% by weight of melamine resin based on the polyester urethane composition at the temperatures of 100 to 300° C. A melamine resin, also known as melamine formaldehyde resin, comprises melamine rings terminated with multiple hydroxyl and/or alkoxy groups. Examples of suitable melamine resins that may be used to crosslink the polyester-urethane disclosed herein include, but are not limited to, highly methylated melamine resins, methylated high imino melamine resins, partially methylated melamine resins, longer chain alkoxylated melamine resins, and mixtures thereof. These may conveniently be in the form of powders or liquids.

### Blocked Polyisocyanate Crosslinking Agent

As is known in the art, blocked polyisocyanates are crosslinking agents in which the isocyanate groups have been reacted with a blocking agent that dissociates into the reactive isocyanate group upon heating and the re-generated isocyanate group reacts with the hydroxy group of a hydroxy functional polyester-urethane of the present invention. Some examples of suitable blocking agents for polyisocyanates include, but are not limited to, aliphatic monohydric alcohols, cycloaliphatic monohydric alcohols, hydroxylamines and ketoximes.

### Polyisocyanate Crosslinker

Since reaction starts immediately after mixing a polyisocyanate with a hydroxy functional polyester-urethane composition of the present invention, such mixing may suitably be done right before applying the coating composition to a substrate. Some examples of suitable polyisocyanates include, but are not limited to, isophorone diisocyanate, 4,4′-diisocyanatodicyclohexylmethane, isophorone diisocyanate biuret, isophorone diisocyanate trimer, hexamethylene diisocyanate trimer, hexamethylene diisocyanate biuret, and mixtures thereof.

### Additives

Any composition as disclosed herein that comprises the inventive hydroxyl functional polyester-urethane may further comprise one or more additives. Non-limiting examples of additives are: dispersants, surfactants, plasticizers, defoamers, thickeners, biocides, rheology modifiers, wetting or spreading agents, leveling agents, conductive additives, adhesion promoters, anti-blocking agents, anti-cratering agents, anti-crawling agents, corrosion inhibitors, anti-static agents, flame retardants, optical brighteners, UV light stabilizers, flattening agents, insecticides, odorants, stain resistant agents, other polymer(s) different from the polyester-urethane of the invention based on the total polymer weight, and mixtures thereof. The different polymer, in addition to the polyester-urethane polymer may be selected from polyester, polyvinylidenefluoride (PVDF), polvinylidene fluoride acrylic polymer, polyurethane, acrylic polymer, silicone modified polyester, silicone modified polyurethane, silicone modified acrylic polymer, polyfluoroethylene vinylether, and mixtures thereof. This additional polymer or mixture thereof may be added to any composition comprising the inventive hydroxyl functional polyester-urethane at a level of up to 5, 10, 15, 20, 25, 30, 35, 40, 45, 50, 55, 60, 65, 70, 75, or 80 weight percent based on the total weight of the additional polymer(s) and the polyester-urethane in the composition.

### Methods and Uses of Coating Compositions Comprising the Polyester-Urethane

Coating compositions comprising the polyester-urethane of the present invention may be applied by conventional techniques as are known in the art, such as dipping, brushing, flowing, or spraying to name a few, onto a variety of substrate surfaces. Suitable substrates may include without limitation, wood, aluminum, fabricated wood, paper, cardboard, textiles, synthetic resins, ceramics, ferrous metals, non-ferrous metals, stone, concrete, plaster, and the like. The product formulation may be used in an indoor or outdoor applications. Outdoor applications may include, without limitation, metal coating applications, rail car coating, agricultural machinery coating, automobile parts coating, wood coatings, architectural coatings and structures, and deck stains. The product formulations may also be useful for adhesive and ink applications.

Non-limiting aspects of the invention may be summarized as follows:

Aspect 1: A hydroxy functional polyester-urethane composition comprising, as polymerized monomers,

a) a polyol comprising at least one aliphatic alkyl ring, wherein the at least one aliphatic alkyl ring bears at least two substituents that each comprise at least one hydroxyl group and wherein the remaining substituents on the aliphatic alkyl ring are selected from the group consisting of hydrogen, C1-C10 alkyl groups, and combinations thereof;

b) a polycarboxyl compound comprising at least one aliphatic alkyl ring bearing at least two substituents that each comprise at least one carboxyl group; wherein the at least one carboxyl group comprises a functional group selected from the group consisting of a carboxylic acid, an alkyl ester, an acyl halide, an anhydride, and combinations thereof; and wherein the remaining constituents on the aliphatic alkyl ring are selected from the group consisting of hydrogen, C1-C10 alkyl groups, and combinations thereof; and

c) a polyisocyanate comprising at least one aliphatic alkyl ring, wherein the at least one aliphatic alkyl ring bears at least two substituents that each comprise at least one isocyanate group wherein the remaining substituents on the aliphatic alkyl ring are selected from the group consisting of hydrogen, C1-C10 alkyl groups, and combinations thereof.

Aspect 2: The hydroxy functional polyester-urethane composition according to Aspect 1, comprising at least 0.0045 moles of aliphatic alkyl rings per gram of the composition.

Aspect 3: The hydroxy functional polyester-urethane composition according to either of Aspect 1 or Aspect 2, wherein the a) polyol comprises at least one six carbon aliphatic alkyl ring.

Aspect 4: The hydroxy functional polyester-urethane composition according to any of Aspects 1-3, wherein the b) polycarboxyl compound comprises at least one six carbon aliphatic alkyl ring.

Aspect 5: The hydroxy functional polyester-urethane composition according to any of Aspects 1-4, wherein at the least two substituents that each comprise at least one carboxyl group are neighboring substituents that together form an anhydride group.

Aspect 6: The hydroxy functional polyester-urethane composition according to any of Aspects 1-5, wherein the c) polyisocyanate compound comprises at least one six carbon aliphatic alkyl ring.

Aspect 7: The hydroxy functional polyester-urethane composition according to any of Aspects 1-6, comprising at least 5 weight percent of the polyol comprising at least one aliphatic alkyl ring.

Aspect 8: The hydroxy functional polyester-urethane composition according to any of Aspects 1-7, comprising at least 5 weight percent of the polycarboxyl compound comprising at least one aliphatic alkyl ring.

Aspect 9: The hydroxy functional polyester-urethane composition according to any of Aspects 1-8, comprising at least 5 weight percent of the polyisocyanate comprising at least one aliphatic alkyl ring.

Aspect 10: The hydroxy functional polyester-urethane composition according to any of Aspects 1-9, wherein the polyol comprising the at least one aliphatic alkyl ring is selected from the group consisting of cyclohexane dimethanol, 4,4′-isopropylidenedicyclohexanol, and mixtures thereof.

Aspect 11: The hydroxy functional polyester-urethane composition according to any of Aspects 1-10, wherein the polycarboxyl compound comprising at least one aliphatic alkyl ring is selected from the group consisting of tetrahydrophthalic anhydride, hexahydrophthalic anhydride, 1,3-cyclohexane dicarboxylic acid, 1,4-cyclohexane dicarboxylic acid, 1,3-cyclohexane dimethyl ester, 1,3-cyclohexane diethyl ester, 1,4-cyclohexane dimethyl ester, 1,4-cyclohexane diethyl ester and mixtures thereof.

Aspect 12: The hydroxy functional polyester-urethane composition according to any of Aspects 1-11, wherein the polyisocyanate comprising at least one aliphatic alkyl ring is selected from the group consisting of isophorone diisocyanate, 4,4′-diisocyanatodicyclohexylmethane, and mixtures thereof.

Aspect 13: The hydroxy functional polyester-urethane composition according to any of Aspects 1-12, wherein:

the polyol comprising the at least one aliphatic alkyl ring is at least one polyol selected from the group consisting of cyclohexane dimethanol, 4,4′-isopropylidenedicyclohexanol, and mixtures thereof;

the polycarboxyl compound comprising at least one aliphatic alkyl ring is at least one polycarboxy compound selected from the group consisting of hexahydrophthalic anhydride, 1,3-cyclohexane dicarboxylic acid, 1,4-cyclohexane dicarboxylic acid, and mixture thereof; and

the polyisocyanate comprising at least one aliphatic alkyl ring is at least one polyisocyanate selected from the group consisting of isophorone diisocyanate, 4,4′-diisocyanatodicyclohexylmethane, and mixtures thereof.

Aspect 14: The hydroxy functional polyester-urethane composition according to any of Aspects 1-13, wherein the composition further comprises an additional polymer different from the hydroxy functional polyester-urethane, the additional polymer being at least one polymer selected from the group consisting of polyester, polyvinylidenefluoride, polvinylidene fluoride acrylic polymer, polyurethane, acrylic polymer, silicone modified polyester, silicone modified polyurethane, silicone modified acrylic polymer, polyfluoroethylene vinylether, and mixtures thereof.

Aspect 15: A crosslinked composition comprising the hydroxy functional polyester-urethane composition according to any of Aspects 1-14, which has been reacted with a crosslinking agent.

Aspect 15: The crosslinked composition according to Aspect 15, wherein the crosslinking agent is selected from the group consisting of a melamine resin, a polyisocyanate, and a blocked polyisocyanate.

Aspect 17: A coating composition comprising the hydroxy functional polyester-urethane composition according to any of Aspects 1-14 and at least one additional component.

Aspect 18: The coating composition according to Aspect 17, wherein the at least one additional component is selected from the group consisting of a polymer different from the hydroxy functional polyester-urethane, an organic solvent, a pigment, and a crosslinking agent.

Aspect 19: The coating composition according to Aspect 18, wherein the crosslinking agent is selected from the group consisting of a melamine resin, a polyisocyanate, and a blocked polyisocyanate.

Aspect 20: The coating composition according to Aspect 19, wherein the crosslinking agent is a blocked polyisocyanate.

Aspect 21: A crosslinked coating composition comprising the crosslinked composition according to either of Aspect 15 or Aspect 16 and at least one additional component.

Aspect 22: The crosslinked coating composition according to Aspect 21 wherein the at least one additional component is selected from the group consisting of a pigment.

### EXAMPLES

The term “high gloss” means 20 degree gloss higher than 75 and 60 degree gloss higher than 90 measured according to the ASTM-D523 test method.

### Comparative Examples 1-4: Synthesis of Comparative Polyester-Urethane Compositions

Various comparative polyester-urethane compositions, comprising less than 0.0045 moles of aliphatic alkyl rings per gram of polyester-urethane composition, were prepared with aliphatic alkyl ring containing polycarboxylic acid or anhydride and aliphatic alkyl ring containing polyisocyanate but without aliphatic alkyl ring containing polyol. Table 1 shows the reactants that were used and certain properties of the polymers formed. All amounts are in grams.

TABLE 1
Comparative Examples 1-4

| | | Comp. | Comp. | Comp. | Comp. |
|---|---|---|---|---|---|
| Charge | | Example 1 | Example 2 | Example 3 | Example 4 |
| (A) | 1,6-Hexanediol | 40 | 40 | 80 | 80 |
| | 1,10-Decanediol | 62 | 62 | 0 | 0 |
| | Hexahydrophthalic anhydride | 0 | 63 | 0 | 63 |
| | 1,4-Cyclohexane dicarboxylic acid | 70 | 0 | 70 | 0 |
| | Xylene | 5 | 5 | 5 | 5 |
| (B) | Propylene glycol monomethyl ether acetate | 110 | 110 | 98 | 98 |
| | Dibutyltin dilaurate | 0.1 | 0.1 | 0.1 | 0.1 |
| (C) | 4,4′-Diisocyanatodicyclohexylmethane | 47 | 47 | 47 | 47 |

Resin Properties

| | | | | |
|---|---|---|---|---|
| Mole of aliphatic alkyl ring per gram of | 0.003745 | 0.003750 | 0.004197 | 0.004202 |
| polyester-urethane composition | | | | |
| Ratio of —OH/—COOH of the reactants | 1.71 | 1.70 | 1.66 | 1.66 |
| (monomers) for the polyester-forming stage | | | | |
| Theoretical hydroxy value of final | 62.0 | 65.5 | 59.0 | 62.0 |
| polyester-urethane | | | | |
| Non-Volatile Solids | 63.7 | 66.1 | 63.4 | 65.5 |
| Brookfield Viscosity | 1250 cps | 1100 cps | 2900 cps | 2600 cps |
| (Spindle #4/60 rpm, 25° C.) | | | | |
| Acid Value (polymer solids) | 2.6 | 7.3 | 3.1 | 7.5 |

Charge (A) was added into a flask equipped with a receiver filled with xylene, a cold water condenser, and nitrogen blanket. The mixture was heated to 220 to 230° C. The polyester forming process continued while removing the forming water until the acid value dropped below 12.0. The temperature was lowered to around 150° C., then Charge (B) was added. The temperature was maintained at 130 to 140° C. and Charge (C) was added to the reaction flask over a period of 20 to 40 minutes. The urethane forming process continued at 130 to 140 ° C. for 2 to 3 hours after the feed of Charge (C) was completed.

### Examples 1-6: Synthesis of Inventive Polyester-Urethane

Various polyester-urethane compositions, having higher than 0.0045 moles of aliphatic alkyl ring per gram of polyester-urethane composition were prepared with aliphatic alkyl ring-containing polyol, aliphatic alkyl ring-containing polycarboxylic acid or anhydride and aliphatic alkyl ring-containing polyisocyanate as described below. Table 2 shows the reactants that were used and certain properties of the polymers formed. All amounts are in grams.

TABLE 2
Examples 1-3 According to the Invention

| Charge | | Example 1 | Example 2 | Example 3 |
|---|---|---|---|---|
| (A) | 1,6-Hexanediol | 69 | 60 | 60 |
| | 4,4′-isopropylidenedicyclohexanol | 25 | 35 | 35 |
| | Hexahydrophthalic anhydride | 63 | 0 | 0 |
| | 1,4-Cyclohexane dicarboxylic acid | 0 | 60 | 60 |
| | Xylene | 5 | 5 | 5 |
| (B) | Propylene glycol monomethyl ether acetate | 106 | 105 | 105 |
| | Dibutyltin dilaurate | 0.1 | 0.1 | 0.1 |
| (C) | 4,4′-Diisocyanatodicyclohexylmethane | 47 | 32 | 52 |
| | Isophorone diisocyanate | 0 | 20 | 0 |

Resin Properties

| | | | |
|---|---|---|---|
| Mole of aliphatic alkyl ring per gram of | 0.004960 | 0.004787 | 0.005331 |
| polyester-urethane composition | | | |
| Ratio of —OH/—COOH of the reactants | 1.68 | 1.68 | 1.68 |
| (monomers) for the polyester-forming stage | | | |
| Theoretical hydroxy value of final | 56.9 | 53.4 | 48.7 |
| polyester-urethane | | | |
| Non-Volatile Solids | 64.5 | 66.7 | 66.2 |
| Brookfield Viscosity | 3600 cps | 24750 cps | 22500 cps |
| (Spindle #4/60 rpm, 25° C.) | | | |
| Acid Value (polymer solids) | 8.2 | 2.6 | 2.5 |

Charge (A) was added into a flask equipped with a receiver filled with xylene, a cold water condenser, and nitrogen blanket and heated to 220 to 230° C. The polyester forming process continued while removing the forming water until the acid value dropped below 12. The temperature was lowered to around 150° C., then Charge (B) was added. The temperature was maintained at 130 to 140° C. and Charge (C) was added to a reaction flask over a period 20 to 40 minutes. The polyurethane forming process continued at 130 to 140° C. for 2 to 3 hours after the feed of Charge (C) is completed.

TABLE 3
Examples 4-5 According to the Invention

| | | Example 4 | Example 5 |
|---|---|---|---|
| Charge | | (B936-198) | (B937-196) |
| (A) | 1,6-Hexanediol | 80 | 57 |
| | 4,4′-isopropylidenedicyclohexanol | 50 | 80 |
| | Hexahydrophthalic anhydride | 50 | 48 |
| | Xylene | 5 | 5 |
| (B) | Propylene glycol monomethyl ether acetate | 131 | 135 |
| | Dibutyltin dilaurate | 0.1 | 0.1 |
| (C) | 4,4′-Diisocyanatodicyclohexylmethane | 50 | 59 |
| | Isophorone diisocyanate | 10 | 0 |
| (D) | Tri-n-butoxy titanate | 0.1 | 0.1 |
| (E) | Trimethoxy propyl silane | 20 | 25 |

Resin Properties

| | | |
|---|---|---|
| Mole of aliphatic alkyl ring per gram of | 0.004813 | 0.005707 |
| polyester-urethane composition | | |
| Ratio of —OH/—COOH of the reactants | 2.73 | 2.62 |
| (monomers) for the polyester-forming stage | | |
| Theoretical hydroxy value of final | 65.7 | 31.6 |
| polyester-urethane | | |
| Non-Volatile Solids | 66.3 | 65.7 |
| Brookfield Viscosity | 1450 cps | 2800 cps |
| (Spindle #4/60 rpm, 25° C.) | | |

Charge (A) was added into a flask equipped with a receiver filled with xylene, a cold water condenser, and nitrogen blanket and heated to 220 to 230° C. The polyester forming process continued while removing the forming water until the acid value dropped below 12. The temperature was lowered to around 150° C., then Charge (B) was added. The temperature was maintained at 130 to 140° C. and Charge (C) was added to a reaction flask over a period 20 to 40 minutes. The polyurethane forming process continued at 130 to 140° C. for 2 to 3 hours after the feed of Charge (C) is completed. The temperature was maintained at 110 to 140° C. and Charge (E) was added. The reaction continued for about 2 hours while collecting forming methanol.

### Preparation of Comparative Examples 1-4 White Paints

Various pigmented coating compositions formulated with the polyester-urethane resins prepared as Comparative Examples 1-4 were produced by mixing the compositions shown in Table 3 below: Charge (A) was mixed in a 16 oz. metal can with high speed stirrer for 20 to 40 minutes followed by mixing Charge (B) with moderate agitation.

TABLE 3
White Paint Comparative Examples 1-4

| | | Comp. | Comp. | Comp. | Comp. |
|---|---|---|---|---|---|
| Charge | | Example 1 | Example 2 | Example 3 | Example 4 |
| (A) | Resin | 91.8 | 88.5 | 92.3 | 89.3 |
| | Propylene glycol monomethyl ether acetate | 10 | 10 | 10 | 10 |
| | N-butoxy diethylene glycol | 10 | 10 | 10 | 10 |
| | DISPERBYK ® 163 (Dispersant) | 4 | 4 | 4 | 4 |
| | R902 ® (Titanium dioxide, rutile) | 140 | 140 | 140 | 140 |
| | Aerosil ®972 (Fumed silica) | 1.25 | 1.25 | 1.25 | 1.25 |
| (B) | Resin | 142.9 | 137.7 | 143.5 | 138.9 |
| | Propylene glycol monomethyl ether acetate | 25.3 | 33.8 | 24.2 | 31.8 |
| | Nacure ® 2558 (10%) | 8.5 | 8.5 | 8.5 | 8.5 |
| | Naphtha solvent A150 (Exxon Mobil) | 29.8 | 29.8 | 29.8 | 29.8 |
| | CRAYVALLAC ® A620 | 2.5 | 2.5 | 2.5 | 2.5 |

| | | | | |
|---|---|---|---|---|
| Total | 466 | 466 | 466 | 466 |
| Polymer Solids | 149.5 | 149.5 | 149.5 | 149.5 |
| Pigment/Polymer | 0.94 | 0.94 | 0.94 | 0.94 |
| Brookfield Viscosity | 500 cps | 380 cps | 920 cps | 550 cps |
| (Spindle #4/60 rpm, 25° C.) | | | | |

Nacure ® 2558 (King Industries) is a partially amine neutralized para-Toluenesulfonic acid (p-TSA) catalyst; CRAYVALLAC ® A-620 is a polyacrylate surface tension modifier.

### Preparation of Inventive White Paint Examples 1-3

Various pigmented coating compositions shown below in Table 4, formulated with the polyester-urethane resins prepared in Examples 1-3 according to the invention were produced by mixing Charge (A) in a 16 oz. metal can with high speed stirrer for 20 to 40 minutes followed by mixing Charge (B) with moderate agitation.

TABLE 4
White Paint Examples 1-3 According to the Invention

| Charge | | Example 1 | Example 2 | Example 3 |
|---|---|---|---|---|
| (A) | Resin | 90.1 | 87.7 | 88.4 |
| | Propylene glycol monomethyl ether acetate | 10 | 10 | 10 |
| | N-butoxy diethylene glycol | 10 | 10 | 10 |
| | DISPERBYK ® 163 (Dispersant) | 4 | 4 | 4 |
| | R902 ® (Titanium dioxide, rutile) | 140 | 140 | 140 |
| | Aerosil ®972 (Fumed silica) | 1.25 | 1.25 | 1.25 |
| (B) | Resin | 140.2 | 136.4 | 137.5 |
| | Propylene glycol monomethyl ether acetate | 29.7 | 35.9 | 34.1 |
| | Nacure ® 2558 (10%) | 8.5 | 8.5 | 8.5 |
| | Naphtha solvent A150 (Exxon Mobil) | 29.8 | 29.8 | 29.8 |
| | CRAYVALLAC ® A620 | 2.5 | 2.5 | 2.5 |

| | | | |
|---|---|---|---|
| Total | 466 | 466 | 466 |
| Polymer Solids | 149.5 | 149.5 | 149.5 |
| Pigment/Polymer | 0.94 | 0.94 | 0.94 |
| Brookfield Viscosity (Spindle #4/60 rpm, 25° C.) | 650 cps | 3020 cps | 4550 cps |

### Preparation of Melamine Cured (Crosslinked) White Paint Films

15 grams of each the paints prepared according to Tables 3 and 4 were mixed with 0.85 grams of CYCMEL® 303 (melamine resin) and were applied on the chromate pretreated aluminum panels using 3 mil drawing bar. After exposure to ambient conditions for 10 to 20 minutes, the aluminum panels were placed in an oven at the temperature of 232° C. for 2 minutes to effect a reaction between the hydroxy functional polyester-urethane and the melamine resin.

### Ultraviolet Light Exposure Test of Melamine Cured White Paint Films (Accelerated Weathering)

The melamine cured white coating on the chromate pre-treated aluminum panel was exposed for 1500 hours to QUV-A accelerated weathering chamber which includes a cycle of 4 hour ultraviolet light of UVA-340 nm irradiation at 60° C. and 4 hour moisture condensation at 50° C.

### Accelerated Weathering Test Results of White Paints (Gloss Retention) Comparative Examples and Examples According to the Invention

The results of the accelerated weathering test of the crosslinked comparative and inventive paint samples on aluminum are shown below. Table 5 shows the results of the comparative Examples 1-4 and Table 6 shows the results of the Examples 1-3 according to the invention.

TABLE 5
QUV-A Accelerated Weathering Results of Comparative
Examples 1-4 Crosslinked White Paints

| | Comparative | Comparative | Comparative | Comparative |
|---|---|---|---|---|
| | Example 1 | Example 2 | Example 3 | Example 4 |
| Mole of aliphatic alkyl ring per gram of | 0.003745 | 0.003750 | 0.004197 | 0.004202 |
| polyester-urethane composition | | | | |
| Percent of OH groups from | 0 | 0 | 0 | 0 |
| aliphatic alkyl ring polyol | | | | |

Gloss(60 degree/20 degree)

| | | | | |
|---|---|---|---|---|
| Initial | 93/85 | 93/85 | 94/86 | 94/87 |
| After 1056 hours QUV-A | 86/63 | 78/44 | 85/60 | 89/71 |
| weathering | | | | |
| % 60 degree gloss retention after | 87.1 | 74.2 | 87.2 | 88.3 |
| 1500 hours QUV-A weathering | | | | |
| % 20 degree gloss retention after | 60.0 | 32.9 | 58.1 | 60.9 |
| 1500 hours QUV-A weathering | | | | |

TABLE 6
Accelerated QUV-A Weathering Results of Examples 1-3
Crosslinked White Paints According to the Invention

| | Example 1 | Example 2 | Example 3 |
|---|---|---|---|
| Mole of aliphatic alkyl ring per gram of | 0.004960 | 0.004787 | 0.005331 |
| polyester-urethane composition | | | |
| Percent of OH groups from aliphatic | 21.4 | 29.9 | 28.1 |
| alkyl ring polyol | | | |

Gloss(60 degree/20 degree)

| | | | |
|---|---|---|---|
| Initial | 94/87 | 94/87 | 94/84 |
| After 1056 hours QUV-A weathering | 93/83 | | |
| After 1560 hours QUV-A weathering | 93/81 | | |
| After 1968 hours QUV-A weathering | | 93/82 | 92/84 |
| % 60 degree gloss retention after | 98.9 | >98.9 | >97.9 |
| 1500 hours QUV-A weathering | | | |
| % 20 degree gloss retention after | 93.1 | >94.2 | 100 |
| 1500 hours QUV-A weathering | | | |

It is surprisingly found that the white pigmented coatings formulated with a polyester-urethane, having greater than 0.0045 mole of alkyl ring per gram of polyester-urethane polymer, prepared from aliphatic alkyl ring containing polyol, aliphatic alkyl ring containing polycarboxylic acid(anhydride) and aliphatic alkyl ring containing polyisocyanate demonstrate remarkably better gloss retention upon exposure for 1500 hours to QUV-A accelerated weathering chamber which includes a cycle of 4 hours ultraviolet light of UVA-340 nm irradiation at 60° C. followed by 4 hour moisture condensation at 50° C.

Within this specification embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings.

1. A hydroxy functional polyester-urethane composition comprising, as polymerized monomers,
a) a polyol comprising at least one aliphatic alkyl ring, wherein the at least one aliphatic alkyl ring bears at least two substituents that each comprise at least one hydroxyl group and wherein the remaining substituents on the aliphatic alkyl ring are selected from the group consisting of hydrogen, C1-C10 alkyl groups, and combinations thereof;
b) a polycarboxyl compound comprising at least one aliphatic alkyl ring bearing at least two substituents that each comprise at least one carboxyl group; wherein the at least one carboxyl group comprises a functional group selected from the group consisting of a carboxylic acid, an alkyl ester, an acyl halide, an anhydride, and combinations thereof; and wherein the remaining constituents on the aliphatic alkyl ring are selected from the group consisting of hydrogen, C1-C10 alkyl groups, and combinations thereof; and
c) a polyisocyanate comprising at least one aliphatic alkyl ring, wherein the at least one aliphatic alkyl ring bears at least two substituents that each comprise at least one isocyanate group, wherein the remaining substituents on the aliphatic alkyl ring are selected from the group consisting of hydrogen, C1-C10 alkyl groups, and combinations thereof.

2. The hydroxy functional polyester-urethane composition according to claim 1, comprising at least 0.0045 moles of aliphatic alkyl rings per gram of the composition.

3. The hydroxy functional polyester-urethane composition according to claim 1, wherein the a) polyol comprises at least one six carbon aliphatic alkyl ring.

4. The hydroxy functional polyester-urethane composition according to claim 1, wherein the b) polycarboxyl compound comprises at least one six carbon aliphatic alkyl ring.

5. The hydroxy functional polyester-urethane composition according to claim 1, wherein at the least two substituents that each comprise at least one carboxyl group are neighboring substituents that together form an anhydride group.

6. The hydroxy functional polyester-urethane composition according to claim 1, wherein the polyisocyanate compound comprises at least one six carbon aliphatic alkyl ring.

7. The hydroxy functional polyester-urethane composition according to claim 1, comprising at least 5 weight percent of the polyol comprising at least one aliphatic alkyl ring.

8. The hydroxy functional polyester-urethane composition according to claim 1, comprising at least 5 weight percent of the polycarboxyl compound comprising at least one aliphatic alkyl ring.

9. The hydroxy functional polyester-urethane composition according to claim 1, comprising at least 5 weight percent of the polyisocyanate comprising at least one aliphatic alkyl ring.

10. The hydroxy functional polyester-urethane composition according to claim 1, wherein the polyol comprising the at least one aliphatic alkyl ring is selected from the group consisting of cyclohexane dimethanol, 4,4′-isopropylidenedicyclohexanol, and mixtures thereof.

11. The hydroxy functional polyester-urethane composition according to claim 1, wherein the polycarboxyl compound comprising at least one aliphatic alkyl ring is selected from the group consisting of tetrahydrophthalic anhydride, hexahydrophthalic anhydride, 1,3-cyclohexane dicarboxylic acid, 1,4-cyclohexane dicarboxylic acid, 1,3-cyclohexane dimethyl ester, 1,3-cyclohexane diethyl ester, 1,4-cyclohexane dimethyl ester, 1,4-cyclohexane diethyl ester and mixtures thereof.

12. The hydroxy functional polyester-urethane composition according to claim 1, wherein the polyisocyanate comprising at least one aliphatic alkyl ring is selected from the group consisting of isophorone diisocyanate, 4,4′-diisocyanatodicyclohexylmethane, and mixtures thereof.

13. The hydroxy functional polyester-urethane composition according to claim 1, wherein:
the polyol comprising the at least one aliphatic alkyl ring is at least one polyol selected from the group consisting of cyclohexane dimethanol, 4,4′-isopropylidenedicyclohexanol, and mixtures thereof;
the polycarboxyl compound comprising at least one aliphatic alkyl ring is at least one polycarboxyl compound selected from the group consisting of hexahydrophthalic anhydride, 1,3-cyclohexane dicarboxylic acid, 1,4-cyclohexane dicarboxylic acid, and mixture thereof; and
the polyisocyanate comprising at least one aliphatic alkyl ring is at least one polyisocyanate selected from the group consisting of isophorone diisocyanate, 4,4′-diisocyanatodicyclohexylmethane, and mixtures thereof.

14. The hydroxy functional polyester-urethane composition according to claim 1, wherein the composition further comprises an additional polymer different from the hydroxy functional polyester-urethane, the additional polymer being at least one polymer selected from the group consisting of polyester, polyvinylidenefluoride, polvinylidene fluoride acrylic polymer, polyurethane, acrylic polymer, silicone modified polyester, silicone modified polyurethane, silicone modified acrylic polymer, polyfluoroethylene vinylether, and mixtures thereof.

15. The hydroxy functional polyester-urethane composition according to claim 1, wherein the composition further comprises silane selected from the group consisting of trimethoxy silane, triethoxy silane, methyl dimethoxy silane, methyl diethoxy silane, methyl trimethoxy silane, methyl triethoxy silane, propyl trimethoxy silane, propyl triethoxy silane, propyl trimethoxy silane, and dimethoxy dimethyl silane and mixtures thereof.

16. A crosslinked composition comprising the hydroxy functional polyester-urethane composition according to claim 1, which has been reacted with a crosslinking agent.

17. The crosslinked composition according to claim 14, wherein the cros slinking agent is selected from the group consisting of melamine resin, polyisocyanate, and blocked polyisocyanate.

18. A coating composition comprising the hydroxy functional polyester-urethane composition according to claim 1 and at least one additional component.

19. The coating composition according to claim 18, wherein the at least one additional component is selected from the group consisting of a polymer different from the hydroxy functional polyester-urethane, an organic solvent, a pigment, and a crosslinking agent.

20. The coating composition according to claim 19, wherein the crosslinking agent is selected from the group consisting of a melamine resin, a polyisocyanate, and a blocked polyisocyanate.

21. The coating composition according to claim 20, wherein the crosslinking agent is blocked polyisocyanate.

22. A crosslinked coating composition comprising the crosslinked composition according to claim 15 and at least one additional component.

23. The crosslinked coating composition according to claim 22 wherein the at least one additional component is selected from the group consisting of a pigment.
